(19) United States
(12) Patent Application Publication
(10) Pub. No.: US 2016/0018759 A1
(43) Pub. Date: Jan. 21, 2016

(54) DEVELOPER CONVEYING DEVICE, IMAGE FORMING APPARATUS

(71) Applicant: KYOCERA Document Solutions Inc., Osaka (JP)

(72) Inventor: Koji Suenami, Osaka-shi (JP)

(21) Appl. No.: 14/799,529

(22) Filed: Jul. 14, 2015

(30) Foreign Application Priority Data
Jul. 17, 2014 (JP) 2014-146416

(51) Int. Cl. G03G 15/08

(52) U.S. Cl. CPC G03G 15/0887

(57) ABSTRACT

A developer conveying device includes a vertical conveyance member and an AC application portion. The vertical conveyance member is an electrically conductive member and conveys developer in a developer conveyance path that extends in a vertical direction, by operating in the path. The AC application portion applies an AC voltage to the vertical conveyance member.

### INCORPORATION BY REFERENCE

This application is based upon and claims the benefit of priority from the corresponding Japanese Patent Application No. 2014-146416 filed on Jul. 17, 2014, the entire contents of which are incorporated herein by reference.

### BACKGROUND

The present disclosure relates to a developer conveying device and an image forming apparatus including the developer conveying device.

Typically, an electrophotographic image forming apparatus includes a developer conveying device including a conveyance member that operates in a developer path so as to convey the developer. The conveyance member conveys the developer, for example, in a path extending in a vertical direction. In that case, the conveyance member may also be referred to as a loosening member or a stirring member because it loosens the developer and facilitates the dropping of the developer in the path.

In addition, there is known a configuration where a rotatable coil-like member is used as the conveyance member in the supply path of the developer in which the developer is supplied to the developing portion for developing an electrostatic latent image on an image carrier.

### SUMMARY

A developer conveying device according to an aspect of the present disclosure includes a vertical conveyance member and an AC application portion. The vertical conveyance member is an electrically conductive member and conveys developer in a developer conveyance path that extends in a vertical direction, by operating in the path. The AC application portion applies an AC voltage to the vertical conveyance member.

An image forming apparatus according to another aspect of the present disclosure includes a developing portion and the developer conveying device according to the aspect of the present disclosure. The developing portion develops an electrostatic latent image on an image carrier by developer.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming apparatus according to an embodiment of the present disclosure.

FIG. 2 is a configuration diagram of a developer conveying device according to an embodiment of the present disclosure.

### DETAILED DESCRIPTION

The following describes an embodiment of the present disclosure with reference to the accompanying drawings. It should be noted that the following description is an example of a specific embodiment of the present disclosure and should not limit the technical scope of the disclosure.

[Outlined Configuration of Image Forming Apparatus 10]

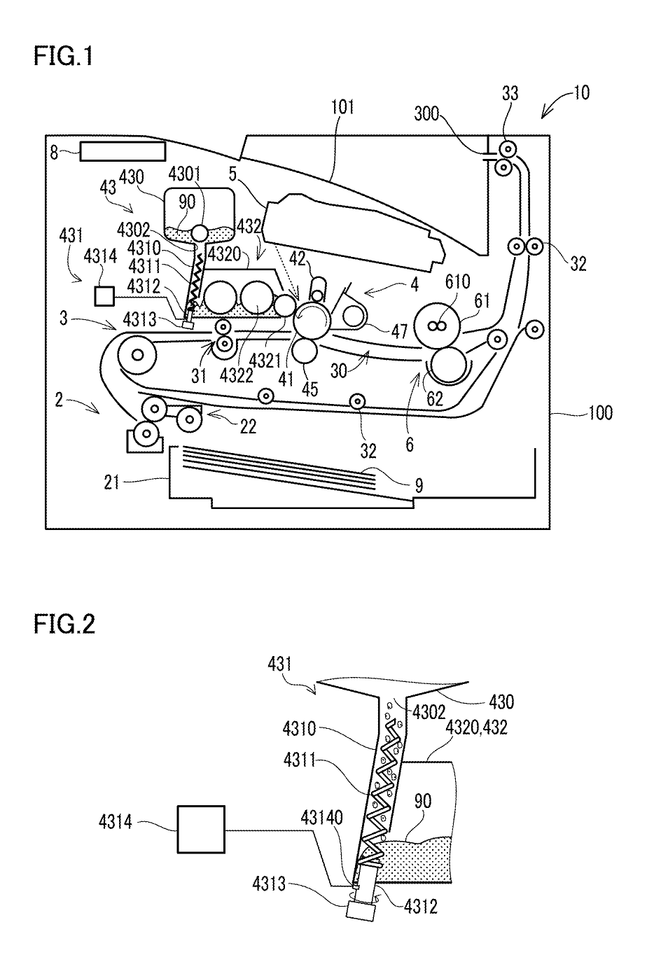

An image forming apparatus 10 according to an embodiment of the present disclosure is an electrophotographic image forming apparatus. As shown in FIG. 1, the image forming apparatus 10 includes, in a housing 100, a sheet supply portion 2, a sheet conveying portion 3, an image forming portion 4, an optical scanning portion 5, a fixing portion 6, an operation display portion 80, and a control portion 8.

It is noted that the image forming apparatus 10 is, for example, a printer, a copier, a facsimile or a multifunction peripheral. The multifunction peripheral has functions of the printer, the copier and the like.

The sheet supply portion 2 includes: a sheet receiving portion 21 in which a plurality of recording sheets 9 are stacked; and a sheet feed portion 22. The sheet feed portion 22 includes a roller that feeds a recording sheet 9 from the sheet receiving portion 21 to a sheet conveyance path 30, by rotating while in contact with the recording sheet 9. It is noted that the recording sheet 9 is a sheet-like image forming medium such as a sheet of paper, a sheet of coated paper, a postcard, an envelope, or an OHP sheet.

The sheet conveying portion 3 includes a resist roller 31, a conveyance roller 32, and a discharge roller 33. The resist roller 31 and the conveyance roller 32 convey the recording sheet 9 that is supplied from the sheet supply portion 2, toward the image forming portion 4. Furthermore, the discharge roller 33 discharges the recording sheet 9 on which an image has been formed, onto a discharge tray 101 from a discharge port of the sheet conveyance path 30.

The image forming portion 4 forms an image on the recording sheet 9 that is supplied from the sheet feed portion 22 and is moving in the sheet conveyance path 30. The image forming portion 4 includes a drum-like photoconductor 41, a charging device 42, a developing device 43, a transfer device 45, and a cleaning device 47. It is noted that the photoconductor 41 is an example of the image carrier.

The photoconductor 41 rotates, and the charging device 42 uniformly charges the surface of the photoconductor 41. In addition, the optical scanning portion 5 writes an electrostatic latent image on the charged surface of the photoconductor 41, by scanning a laser beam thereon. Furthermore, the developing device 43 develops the electrostatic latent image by supplying developer 90 to the photoconductor 41.

The developer 90 is, for example, a two-component developer that is composed of carrier and toner, among which the carrier has magnetism. The developer 90 may be composed of only toner, without including the carrier. That is, the developer 90 may be a one-component developer. The developer 90 is charged to plus or minus.

The developing device 43 includes a developer container 430, a developer conveying device 431, and a developing portion 432. The developer container 430 is a container storing the developer 90, and is attached to the housing 100 (main body) of the image forming apparatus 10 in a detachable manner.

The developer 90 is conveyed in a lateral direction to a supply port 4302 by a first lateral conveyance member 4301 that rotates in the developer container 430. The supply port 4302 is an opening formed in the developer container 430.

The first lateral conveyance member 4301 is, for example, a screw-type conveyance member that includes a shaft portion and a blade portion helically formed around the shaft portion. The first lateral conveyance member 4301 operates when an image forming job occurs. The first lateral conveyance member 4301 operates, for example, for a time period that corresponds to the printing rate of the image forming job.

The developer 90 drops downward from the supply port 4302. This allows the developer 90 to be supplied from the developer container 430 to the developer conveying device 431 that is connected to the supply port 4302.

The developer conveying device 431 is configured to supply the developer 90 to the developing portion 432 by conveying the developer 90 supplied from the developer container 430 from above to below. Thus the developer conveying device 431 may be referred to as a developer vertical conveying device. The developer conveying device 431 is described below in detail.

The developing portion 432 develops the electrostatic latent image on the photoconductor 41 by the developer 90 supplied from the developer conveying device 431. The developing portion 432 includes a development tank 4320, a developing roller 4321, and a second lateral conveyance member 4322.

The development tank 4320 is a container for temporarily storing the developer 90 supplied from the developer conveying device 431. The second lateral conveyance member 4322 conveys, while stirring, the developer 90 in the development tank 4320 in the lateral direction.

More specifically, the second lateral conveyance member 4322 conveys the developer 90 in the lateral direction from the vicinity of the developer conveying device 431 to a peripheral of the developing roller 4321. The second lateral conveyance member 4322 is, for example, a screw-type conveyance member that includes a shaft portion and a blade portion that is helically formed around the shaft portion. It is noted that the lateral direction includes a horizontal direction and such directions that form acute angles to the horizontal direction.

The developing roller 4321 rotates at a position where it faces the photoconductor 41, thereby supplying the developer 90 from the development tank 4320 to the surface of the photoconductor 41. The developing roller 4321 may be referred to as a developing sleeve.

The transfer device 45 transfers an image (the developer 90) on the surface of the photoconductor 41 to the recording sheet 9 that is moving in the sheet conveyance path 30. Lastly, the cleaning device 47 removes the developer 90 that has remained on the surface of the photoconductor 41.

The fixing portion 6 nips the recording sheet 9 with an image formed thereon, between a fixing roller 61, in which is embedded a heater 610 such as a halogen heater, and a pressure roller 62 and feeds the sheet to a downstream process. In this operation, the fixing portion 6 heats the developer 90 on the recording sheet 9 and fixes the image to the recording sheet 9.

The control portion 8 controls various types of devices included in the image forming apparatus 10. For example, when an image forming job occurs, the control portion 8 causes a drive portion of the first lateral conveyance member 4301, the developer conveying device 431, and a drive portion of the second lateral conveyance member 4322 and the developing roller 4321 to operate.

[Developer Conveying Device 431]

As shown in FIG. 2, the developer conveying device 431 includes a developer supply duct 4310, a vertical conveyance member 4311, a rotation shaft portion 4312, a rotation drive portion 4313, and an AC application portion 4314.

The developer supply duct 4310 is a duct that forms a vertically extending path of the developer 90. The developer supply duct 4310 forms a path that connects the developer container 430 with the development tank 4320. That is, the developer supply duct 4310 is a supply path for supplying the developer 90 to the developing portion 432. It is noted that the vertical direction includes the perpendicular direction and such directions that form acute angles to the perpendicular direction.

The vertical conveyance member 4311 is an electrically conductive member that operates in the path formed by the developer supply duct 4310 so as to convey the developer 90 from above to below. In the present embodiment, the vertical conveyance member 4311 is a coil-like member that rotates in the path formed by the developer supply duct 4310. The vertical conveyance member 4311 may be, for example, a metal member made of stainless steel.

It is noted that the vertical conveyance member 4311 can also be referred to as a loosening member or a stirring member since it loosens and facilitates the developer 90 to drop in the path formed by the developer supply duct 4310.

The rotation shaft portion 4312 is an electrically conductive member connected to an end portion of the vertical conveyance member 4311. The rotation shaft portion 4312 is also a terminal that electrically connects the vertical conveyance member 4311 with an output end 43140 of the AC application portion 4314. The rotation shaft portion 4312 may be, for example, a metal member made of stainless steel.

The rotation drive portion 4313 is a mechanism for rotationally driving the rotation shaft portion 4312. The rotation drive portion 4313 is, for example, a gear mechanism that operates in conjunction with a driving source such as a motor or the rotation of the driving source.

The rotation drive portion 4313 is either in an operation state or in a stop state based on a control signal from the control portion 8, wherein in the operation state, the rotation drive portion 4313 rotationally drives the rotation shaft portion 4312, and in the stop state, the rotation drive portion 4313 stops the rotation of the rotation shaft portion 4312.

For example, the rotation drive portion 4313 is in the operation state while the first lateral conveyance member 4301 operates, and is in the stop state while the first lateral conveyance member 4301 stops operating, wherein the first lateral conveyance member 4301 is a mechanism for supplying the developer 90 to the developer conveying device 431. As another example, the rotation drive portion 4313 may be in the operation state while the first lateral conveyance member 4301 operates and for a predetermined period after the first lateral conveyance member 4301 stops operating, and then be in the stop state until the first lateral conveyance member 4301 starts operating again.

Meanwhile, the developer 90 may be stuck and accumulated on the vertical conveyance member 4311 depending on the installation environment of the developer conveying device 431, such as a high-humidity environment. When the developer 90 is accumulated on the vertical conveyance member 4311, the path (the developer supply duct 4310) may be clogged with the developer 90, and a conveyance failure of the developer 90 may occur.

On the other hand, the developer conveying device 431 can prevent the developer 90 from accumulating on the vertical conveyance member 4311, by the action of the AC application portion 4314 as described below.

The AC application portion 4314 is a circuit for applying an AC voltage to the vertical conveyance member 4311. In the present embodiment, the AC application portion 4314 applies an AC voltage to the vertical conveyance member 4311 via the rotation shaft portion 4312 that is electrically conductive.

More specifically, the AC application portion 4314 applies, to the vertical conveyance member 4311, an AC voltage that changes its polarity between the polarity of the charged developer 90 and the opposite polarity.

The AC application portion 4314 may be, for example, a well-known AC bias circuit that outputs an AC bias voltage. In that case, the AC bias voltage is applied to the vertical conveyance member 4311. In the present embodiment, the output end 43140 of the AC application portion 4314 is supported in a state where it is slidable on the rotation shaft portion 4312. With this configuration, the AC application portion 4314 can apply an AC voltage to the rotation shaft portion 4312 and the vertical conveyance member 4311 while they are rotating.

With adoption of the developer conveying device 431, the developer 90 is vibrated near the surface of the vertical conveyance member 4311 due to the polarity change of the vertical conveyance member 4311 which is caused by the applied AC voltage. That is, the developer 90 that contacts the vertical conveyance member 4311 is periodically removed from the vertical conveyance member 4311 by electrical repulsion. As a result, it is possible to prevent the developer 90 from being accumulated on the vertical conveyance member 4311.

It is noted that the vibration of the vertical conveyance member 4311 is difficult to be transmitted to the developing roller 4321 and the photoconductor 41 since the vibration is generated in the developer supply duct 4310 that is the prior stage to the developing portion 432. As a result, the vibration of the vertical conveyance member 4311 is considered to have a negligible effect on the image quality.

The AC application portion 4314 may apply to the vertical conveyance member 4311, for example, an AC voltage having a frequency that is an integer multiple of the natural vibration frequency of the vertical conveyance member 4311. In other words, the AC application portion 4314 may apply, to the vertical conveyance member 4311, an AC voltage having the resonance frequency of the vertical conveyance member 4311. In that case, the vertical conveyance member 4311 is likely to vibrate by sympathetic vibration due to the AC voltage.

The vibration of the vertical conveyance member 4311 further increases the effect of preventing the accumulation of the developer 90 on the vertical conveyance member 4311. In addition, when the vertical conveyance member 4311 is a coil-like member, its vibration is facilitated.

The AC application portion 4314 is either in an application state or in a non-application state based on a control signal from the control portion 8, wherein in the application state, the AC application portion 4314 applies the AC voltage to the vertical conveyance member 4311, and in the non-application state, the AC application portion 4314 stops the application of the AC voltage. For example, the AC application portion 4314 may be in the non-application state while the vertical conveyance member 4311 stops operating. In that case, the application of the AC voltage may be stopped as soon as the vertical conveyance member 4311 stops operating. As another example, the application of the AC voltage may be stopped when a predetermined period of time passes after the vertical conveyance member 4311 stops operating.

Results of experiments indicate that the conveyance efficiency of the developer 90 is much higher under an objective condition than under a comparative condition, wherein under the objective condition, the AC voltage is applied to the vertical conveyance member 4311, and under the comparative condition, the AC voltage is not applied.

In the above-mentioned experiments, the natural vibration frequency of the coil-like vertical conveyance member 4311 was 16 Hz, the objective condition was that the AC voltage (AC bias voltage) of 800 Hz was applied to the vertical conveyance member 4311, and the comparative condition was that the AC voltage was not applied. It is noted that in the experiments described below, the supply speed of the developer 90 is supposed to be the weight of the developer 90 that is supplied (conveyed) per unit time.

In the first experiment, the developer 90 was supplied from the developer container 430 to the developer supply duct 4310 at a speed that is sufficiently high as not to cause the developer supply duct 4310 to be clogged with the developer 90. In this case, the supply speed of the developer 90 that was supplied from the developer supply duct 4310 to the development tank 4320 under the objective condition was approximately 1.65 times the supply speed under the comparative condition.

Furthermore, the weight of the developer 90 stuck on the vertical conveyance member 4311 after the first experiment under the objective condition was approximately 41% smaller than that under the comparative condition.

The results of the first experiment show that, with adoption of the AC application portion 4314, a power saving effect is obtained by the reduction of the operation time of the rotation drive portion 4313, and a space saving effect is obtained by the reduction of the size of the developer supply duct 4310 and the like.

In the second experiment, the speed at which the developer 90 was supplied from the developer container 430 to the developer supply duct 4310 was gradually accelerated, and the speed limit, namely, the speed at which the developer supply duct 4310 was clogged with the developer 90 was measured. According to the experiment, under the objective condition, the developer supply duct 4310 was not clogged even when the developer 90 was supplied to the developer supply duct 4310 at a speed 1.57 times the speed limit under the comparative condition.

The results of the second experiment show that, with adoption of the AC application portion 4314, the image forming apparatus 10 can operate for a long time period stably.

In addition, as described above, the vertical conveyance member 4311 operates while the first lateral conveyance member 4301 of the prior stage operates to convey the developer 90, and stops operating while the first lateral conveyance member 4301 stops operating. As a result, when the AC application portion 4314 stops the application of the AC voltage while the vertical conveyance member 4311 stops operating, it is possible to restrict wasteful power consumption without deteriorating the effect of preventing the accumulation of the developer 90.

In the present embodiment, the portion to which the developer conveying device 431 is applied (the path of the developer 90) is the supply path in which the developer 90 is supplied to the developing portion 432. The developer 90 that passes through such a supply path is charged with a predetermined polarity (either plus or minus) almost certainly, as is different from the waste developer that is collected by the cleaning device 47. As a result, the application of the AC voltage makes it easier to obtain the effect of periodically removing the developer 90 from the vertical conveyance member 4311.

### APPLICATION EXAMPLES

The developer conveying device 431 may be applied to a path in which the used developer 90 is conveyed from the cleaning device 47 to a waste developer collecting container (not shown). Here, the waste developer collecting container is a container attached to the image forming apparatus 10 in a detachable manner.

In addition, in the developer conveying device 431, the vertical conveyance member 4311 may be a screw-type conveyance member that includes a shaft portion and a blade portion helically formed around the shaft portion.

It is noted that the developer conveying device and the image forming apparatus of the present disclosure may be configured by freely combining the above-described embodiment and application examples, or by modifying the embodiment and application examples or omitting a part thereof.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A developer conveying device comprising:
an electrically conductive vertical conveyance member configured to convey developer in a developer conveyance path that extends in a vertical direction, by operating in the path; and
an AC application portion configured to apply an AC voltage to the vertical conveyance member.

2. The developer conveying device according to claim 1, wherein the vertical conveyance member is a coil-like member that rotates in the path.

3. The developer conveying device according to claim 1, wherein
the AC application portion applies, to the vertical conveyance member, an AC voltage having a frequency that is an integer multiple of a natural vibration frequency of the vertical conveyance member.

4. The developer conveying device according to claim 1, wherein
the AC application portion stops application of the AC voltage to the vertical conveyance member while the vertical conveyance member stops operating.

5. The developer conveying device according to claim 1, wherein
the path is a supply path for supplying the developer to a developing portion that develops an electrostatic latent image on an image carrier.

6. An image forming apparatus comprising:
a developing portion configured to develop an electrostatic latent image on an image carrier by developer; and
a developer conveying device, wherein
the developer conveying device includes:
an electrically conductive vertical conveyance member configured to convey the developer in a developer conveyance path that extends in a vertical direction, by operating in the path; and
an AC application portion configured to apply an AC voltage to the vertical conveyance member.
